(19) United States
(12) Patent Application Publication
(10) Pub. No.: US 2016/0297148 A1
(43) Pub. Date: Oct. 13, 2016

(54) METHOD FOR EVALUATING AT LEAST ONE COMPONENT LAYER MANUFACTURED BY MEANS OF AN ADDITIVE POWDER LAYER METHOD

(71) Applicant: MTU Aero Engines AG, Munich (DE)

(72) Inventor: Alexander Ladewig, Bad Wiessee (DE)

(21) Appl. No.: 15/094,209

(22) Filed: Apr. 8, 2016

(30) Foreign Application Priority Data
Apr. 13, 2015 (EP) 15163367.4

(51) Int. Cl. B29C 67/00; B22F 3/105; B23K 26/342

(52) U.S. Cl. CPC B29C 67/0088; B29C 67/0077; B23K 26/342; B22F 3/1055; B22F 2003/1057; B33Y 10/00

(57) ABSTRACT

The invention relates to a method for evaluating at least one component layer manufactured by an additive powder layer method, in which at least the following steps are carried out: capturing an image of the at least one component layer by a sensor device; dividing the image into a multiple number of image segments by a computing device; determining a homogeneity value for each image segment by the computing device; and evaluating the component layer based on the determined homogeneity values by the computing device. In addition, the invention relates to a device for implementing such a method.

### BACKGROUND OF THE INVENTION

Additive powder layer methods denote processes in which powder-form material is deposited layer by layer, based on digital 3D construction data, in order to construct a component. Thus, additive powder layer methods differ from conventional material removal or primary forming fabrication methods. For example, instead of milling a workpiece out of a solid block, such additive manufacturing methods construct components layer by layer from one or more materials. Examples of additive powder layer methods are laser sintering or laser melting methods that are used, for example, for the manufacture of components for aircraft engines. Such a method is already known from DE 10 2004 017 769 B4. In the case of the selective laser melting (SLM) method, thin powder layers of the material or materials used are applied onto a construction platform and are locally melted by one or more laser beams, whereby a component layer is formed. Subsequently, the construction platform is lowered, another powder layer is applied and again solidified locally to form the next component layer. This cycle is repeated until the finished component is obtained. Subsequently, the finished component can be further processed as needed or can be used immediately. In the case of selective laser sintering, the component is manufactured in a similar way by laser-assisted sintering of powder-form materials.

For the SLM method, when the laser beam strikes the powder bed, powder particles and/or a portion of the molten material can be expelled in an undesired manner from the working field. This so-called ejection from the melting bath can again land on the powder bed being processed. When a powder site having such an (increased) ejection is melted, it happens that the powder actually accumulated receives too little energy, and, correspondingly, the powder is not melted or is not completely melted. How strong the effect of this melting-bath ejection is also depends on the respective process parameters, for example, the exposed component surface, the material, the layer thickness, etc. Under unfavorable conditions, it may happen in this regard that the amount of ejected material increases and the ejected material is deposited on surface regions yet to be processed. In the next laser exposure, this leads to an unforeseen and inadmissible increase in the quantity of powder, which in turn results in binding defects and has an adverse effect on the component properties. At the moment when a powder accumulation is overwelded, the radiation emitted due to the melting is weakened (attenuated). The back-reflection of the powder or component layer, for example, can be detected as an image by a camera and can be evaluated by a computing device, whereby normally an image is recorded for each component layer and averaging is conducted for evaluation with mathematical methods.

However, it has turned out to be a disadvantage here that, relative to the surface of the component layer, the normally small number of ejections and defective sites resulting therefrom cannot be detected or at least cannot be reliably detected in the component layer. Therefore, component layers that are actually defective are in part classified erroneously as acceptable.

### SUMMARY OF THE INVENTION

The object of the present invention is to create a more reliable method for evaluating at least one component layer manufactured by an additive powder layer method. Another object of the invention is to create a device for implementing such a method.

The objects are achieved according to a method and device of the present invention. Advantageous embodiments with appropriate enhancements of the invention are discussed in detail below and wherein advantageous embodiments of the method are to be viewed as advantageous embodiments of the device, and vice versa.

A first aspect of the invention relates to a method for evaluating at least one component layer manufactured by an additive powder layer method, wherein a more reliable evaluation is achieved according to the invention in that at least the following steps are carried out: capturing an image of the at least one component layer by a sensor device; dividing the image into a multiple number of image segments by a computing device; determining a homogeneity value for each image segment by the computing device; and evaluating the component layer based on the determined homogeneity values by the computing device. In other words, it is provided according to the invention that first an image of the manufactured component layer is captured by a sensor device. Subsequently, the image, which is preferably present in digitized form, is divided by the computing device into several image segments. For dividing the image into image segments, for example, an appropriate grid can be formally placed over the image. The number, form, and division of the image segments, in this case, can be selected, for example, as a function of the surface or the geometry of the component segment, the resolution of the image, and the like. Subsequently, a homogeneity value is determined for each image segment, according to which the component layer is evaluated on the basis of the homogeneity values determined for the individual image segments. In this case, defect-free or unobjectionable component layer regions basically have a high degree of homogeneity, whereas defective component layer regions such as, for example, regions on which ejected material had deposited prior to the melting have a comparatively low homogeneity due to their non-uniform surface characteristics. By not evaluating the image as a whole within the scope of the method according to the invention, but first dividing it into several image segments and subjecting these segments individually to a homogeneity calculation, relatively small defective sites can also be detected based on differences and deviations of individual homogeneity values and taken into consideration in the evaluation. This makes possible a better quality evaluation of the individual component layers, whereby a better evaluation of the overall quality of the finished component is also made possible.

In an advantageous embodiment of the invention, the image is captured as a gray-scale image by the sensor device and/or is pre-processed after capture by the computing device; in particular, it is converted into a gray-scale image. In the framework of the invention, gray scale denotes gradations between pure white and pure black. Since gray scales represent brightness values, a particularly simple and rapid evaluation of the individual image segments and a correspondingly simple and rapid determination of the homogeneity values is made possible for each image segment. Gray values can be filed in a memory of the computing device, for example, as an 8-bit value between 0 and 255 or in hexadecimal notation as a value between #00 and #FF. Correspondingly, images that are present as a 16-bit gray-scale image may contain gray values between 0 and 65535. Basically, coarser or finer gradations of the gray value can be provided. In contrast to this, color images that basically can also be used as the image, of course, lead to multidimensional value distributions that are more complicated to evaluate. Alternatively or additionally, the image can be pre-processed in another way by the computing device. This is particularly meaningful in the case of distorted images. Possible causes for interference are, for example non-homogeneous illumination, contaminants, or disturbances in the sensor device, problems in the sensor optics (edge bleed, distortions, etc.), non-linearities of the sensor device, noise in the capture or evaluation electronics, couplings, and the like. A pre-processing of the image can comprise, for example, a normalizing of gray scales and/or of the image geometry, correction or suppression of disturbances, extraction of features for the control or parameterization of algorithms, and/or obtaining invariant properties.

Other advantages result by dividing the image into image segments of equal size and/or square segments. This permits a particularly simple processing of the image and a correspondingly rapid and simple evaluation of the determined homogeneity values. For example, each image segment can have an edge length that amounts to between 1/10^{th} and 1/100^{th} of the edge length of the image, thus for example: 1/10, 1/11, 1/12, 1/13, 1/14, 1/15, 1/16, 1/17, 1/18, 1/19, 1/20, 1/21, 1/22, 1/23, 1/24, 1/25, 1/26, 1/27, 1/28, 1/29, 1/30, 1/31, 1/32, 1/33, 1/34, 1/35, 1/36, 1/37, 1/38, 1/39, 1/40, 1/41, 1/42, 1/43, 1/44, 1/45, 1/46, 1/47, 1/48, 1/49, 1/50, 1/51, 1/52, 1/53, 1/54, 1/55, 1/56, 1/57, 1/58, 1/59, 1/60, 1/61, 1/62, 1/63, 1/64, 1/65, 1/66, 1/67, 1/68, 1/69, 1/70, 1/71, 1/72, 1/73, 1/74, 1/75, 1/76, 1/77, 1/78, 1/79, 1/80, 1/81, 1/82, 1/83, 1/84, 1/85, 1/86, 1/87, 1/88, 1/89, 1/90, 1/91, 1/92, 1/93, 1/94, 1/95, 1/96, 1/97, 1/98, 1/99 or 1/100. Alternatively or additionally, each image segment can have a size, for example, between 10×10 and 100×100 pixels, thus 10×10, 11×11, 12×12, 13×13, 14×14, 15×15, 16×16, 17×17, 18×18, 19×19, 20×20, 21×21, 22×22, 23×23, 24×24, 25×25, 26×26, 27×27, 28×28, 29×29, 30×30, 31×31, 32×32, 33×33, 34×34, 35×35, 36×36, 37×37, 38×38, 39×39, 40×40, 41×41, 42×42, 43×43, 44×44, 45×45, 46×46, 47×47, 48×48, 49×49, 50×50, 51×51, 52×52, 53×53, 54×54, 55×55, 56×56, 57×57, 58×58, 59×59, 60×60, 61×61, 62×62, 63×63, 64×64, 65×65, 66×66, 67×67, 68×68, 69×69, 70×70, 71×71, 72×72, 73×73, 74×74, 75×75, 76×76, 77×77, 78×78, 79×79, 80×80, 81×81, 82×82, 83×83, 84×84, 85×85, 86×86, 87×87, 88×88, 89×89, 90×90, 91×91, 92×92, 93×93, 94×94, 95×95, 96×96, 97×97, 98×98, 99×99 or 100×100 pixels. Likewise, it can be provided that each image segment images a surface area of 0.1 mm², 0.2 mm², 0.3 mm², 0.4 mm², 0.5 mm², 0.6 mm², 0.7 mm², 0.8 mm², 0.9 mm², 1.0 mm², 1.1 mm², 1.2 mm², 1.3 mm², 1.4 mm², 1.5 mm², 1.6 mm², 1.7 mm², 1.8 mm², 1.9 mm², 2.0 mm², 2.1 mm², 2.2 mm², 2.3 mm², 2.4 mm², 2.5 mm², 2.6 mm², 2.7 mm², 2.8 mm², 2.9 mm², 3.0 mm², 3.1 mm², 3.2 mm², 3.3 mm², 3.4 mm², 3.5 mm², 3.6 mm², 3.7 mm², 3.8 mm², 3.9 mm², 4.0 mm², 4.1 mm², 4.2 mm², 4.3 mm², 4.4 mm², 4.5 mm², 4.6 mm², 4.7 mm², 4.8 mm², 4.9 mm², 5.0 mm² or more of the component layer.

In another advantageous embodiment of the invention, it is provided that the image is divided into image segments only in image regions that contain at least one partial image of the component layer, and/or that the image is divided into image segments such that each image segment contains at least one partial image of the component layer. In other words, it is provided that only those image segments that image at least one part of the component layer are considered. Conversely, image segments on which a component layer is not imaged are not considered in the evaluation. It is ensured thereby that the evaluation is not adversely affected by image segments that have no relation to the component layer being evaluated, and, for example, only depict the structural space of a laser melting production unit, or the like. Moreover, the processing time is shortened, since homogeneity values need be determined and evaluated only for quality-relevant image segments. In this case, it is basically possible to first divide the entire image into image segments and subsequently to discard the non-relevant image segments prior to further processing. Likewise, it can be provided that the image is divided into image segments from the start only in the region of the component layer. In addition, it can be provided that the image is divided into image segments such that each image segment contains a partial image of the component layer.

In another advantageous embodiment of the invention, it is provided that edge regions of the component layer are considered when determining the homogeneity values. In this way edge effects at component edges can be better taken into consideration in the evaluation.

In another embodiment of the invention, it is provided that at least one homogeneity value is determined on the basis of a frequency distribution of an image segment, in particular based on a histogram, and/or based on a co-occurence matrix of an image segment, and/or based on at least one parameter from the group: color maximum value, color minimum value, and mean value. A homogeneity value for the image segment in question can be determined particularly rapidly and simply by a frequency distribution. In particular, the statistical frequency of gray values in the image segment, for example, by a histogram can be employed for determining the homogeneity value. In this case, a narrow frequency distribution corresponds to a high homogeneity value, whereas a broad frequency distribution corresponds to a low homogeneity value. Alternatively or additionally, the homogeneity value can be determined based on a co-occurrence matrix of the image segment in question. The co-occurrence matrix describes the frequency of occurrence of value pairs, in particular pairs of gray values, along a displacement vector and permits the evaluation of the combined probability of the value pairs. Therefore, the nature of the component layer region depicted by the observed image segment can be particularly precisely characterized by the thus determined homogeneity value. Alternatively or additionally, the homogeneity value can be determined on the basis of at least one parameter from the group: color maximum value, color minimum value, and mean value. An unusual mean value as well as a comparatively high deviation between the mean value and a color maximum value or color minimum value generally correspond to a low homogeneity value, and vice versa.

In another advantageous embodiment of the invention, at least two manufactured component layers are evaluated. A three-dimensional evaluation of additively manufactured component regions is made possible thereby, whereby irregularities in the material structure can be determined particularly precisely and reliably.

Other advantages result by varying at least one process parameter of the additive powder layer method for the following component layer, as a function of the evaluation. In other words, it is provided that the evaluation is carried out as a sequential online control between the manufacture of successive component layers. By recognizing process disruptions or structural defects in this way, relevant process parameters can be varied in order to eliminate or at least to minimize defective sites in the component. For example, the following processes parameters can be adjusted as a function of the evaluation: the laser power, the uniformity of the powder application, the layer thickness, the traverse path of a construction platform used for the laser sintering and/or laser melting, a strip overlap of the laser exposure or other exposure parameters.

In another advantageous embodiment of the invention, an inadmissible powder accumulation and/or an inadmissible ejection from the melting bath is revealed when at least two homogeneity values are dissimilar to one another, violating a predetermined threshold value. In other words, the presence of at least one component defect is revealed when at least two homogeneity values greatly differ from what would have been expected proceeding from the targeted nature of the component layer. In particular, in the case of homogeneity values that belong to spatially adjacent image segments, unexpected abrupt jumps signal the presence of a defective component layer region. A dissimilarity index can thus be employed as a measure for describing the (unequal) spatial distribution of the homogeneity values. The dissimilarity index compares the spatial distribution of two homogeneity values by determining the respective percentage values for the image segment on the image for both groups, and by summing up the difference in percentage values over all image segments and multiplying by 0.5. The dissimilarity index varies between 0 and 100 and indicates what percentage of the homogeneity values had to be redistributed for a distribution that was spatially the same.

In another advantageous embodiment of the invention, it is provided that the at least one component layer is classified as admissible, if the homogeneity values satisfy a predetermined variation criterion, or that the at least one component layer is classified as inadmissible if the homogeneity values do not satisfy a predetermined variation criterion. Expressed in another way, the homogeneity values should only have a pre-defined standard deviation in order for the component layer to be classified as admissible. This also permits a simple evaluation and quality assessment of the component layer.

A second aspect of the invention relates to a device for implementing a method according to the first aspect of the invention. In this case, the device comprises at least one sensor device that is designed to capture an image of at least one component layer manufactured by an additive powder layer method, and a computing device that is designed to divide the image into a multiple number of image segments, to determine a homogeneity value for each image segment, and to evaluate the component layer based on the determined homogeneity values. The device according to the invention thus makes possible an improved evaluation of additively manufactured component layers, since comparatively small defective sites can also be detected based on differences and deviations of individual homogeneity values, and can be taken into consideration in the evaluation. This makes possible a better quality evaluation of the individual component layers, whereby a better evaluation of the overall quality of the finished component is also made possible. Additional features and advantages thereof can be derived from the descriptions of the first aspect of the invention, wherein advantageous embodiments of the first aspect of the invention are to be viewed as advantageous embodiments of the second aspect of the invention, and vice versa.

In an advantageous embodiment of the invention, it is provided that the sensor device comprises at least one high-resolution detector and/or at least one IR-sensitive detector, in particular a CMOS and/or sCMOS and/or CCD camera for capturing IR radiation. Detectors or cameras of the named structural type are able to replace the most available CCD image sensors. In comparison to the previous generations of CCD-based cameras or sensors, cameras based on CMOS and sCMOS sensors offer various advantages, such as, for example, a very low readout noise, a high frame rate, a wide dynamic range, a high quantum efficiency, a high resolution, as well as a large sensor surface. This makes possible a particularly precise capture of an image of the component layer as well as a corresponding precise determination of homogeneity values of the image divided into individual image segments, whereby a particularly reliable evaluation of the manufactured component layer is achieved.

Additional advantages result if the device comprises an additive laser sintering and/or laser melting device, by which the at least one component layer can be manufactured. In this way, a sequential online control of the individual manufactured component layers can be carried out. In addition, there exists the possibility of controlling the additive laser sintering and/or laser melting device as a function of the evaluation of a component layer, so that the next component layer can be manufactured such that any structural disturbances and other component defects are repaired or compensated for.

### BRIEF DESCRIPTION OF THE DRAWING FIGURES

Additional features of the invention result from the claims, the exemplary embodiment, as well as on the basis of the drawing. The features and combinations of features named in the preceding description, as well as the features and combinations of features named in the example of embodiment below can be used not only in the combination indicated in each case, but also in other combinations, without departing from the scope of the invention. Thus, embodiments of the invention that are not explicitly shown and explained in the embodiment examples, but become apparent from the embodiments explained and can be produced by separate combinations of features, are also to viewed as comprised and disclosed. Embodiments and combinations of features that thus do not have all features of an originally formulated independent claim are also to be viewed as disclosed. Here:

FIG. 1 shows an image of a component layer manufactured by an additive laser melting method; and

FIG. 2 shows calculated homogeneity values for the image divided into image segments.

### DESCRIPTION OF THE INVENTION

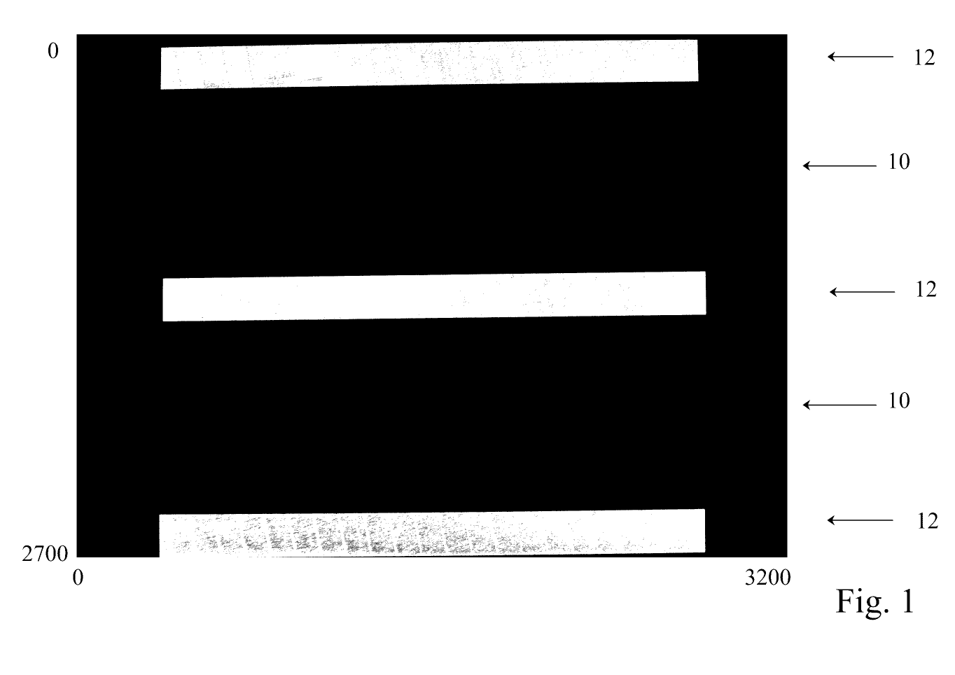

FIG. 1 shows an image of a component layer manufactured by an additive laser melting method. The image was recorded by optical tomography (OT image) as a gray-scale image with a color depth of 16 bits, and can thus contain gray values between 0 and 65535. The resolution of the gray-scale image is 3200×2700 pixels. As is recognized in FIG. 1, the component layer has a high homogeneity due to region 10 characterized by low gray values. At the upper edge, in the center and at the lower edge of the component layer are found three linear regions 12 that were produced by laser exposure of a powder material during the additive laser melting method. The linear regions 12 appear relatively uniform, but actually have a relatively non-uniform nature, since different local inhomogeneities were caused by inadmissible powder accumulation, ejections from the melting bath, or other process disruptions.

In order to reliably evaluate these inhomogeneities and thus the quality of the component layer, the recorded gray-scale image is divided into a total of 3456 image segments of the same size by a computing device, after which a homogeneity value is determined for each image segment by the computing device. It can be provided in this case that only image segments that image a partial region of the component layer can be considered. Likewise, edge effects at the edges of the component layer can be considered in the subsequent determination of homogeneity values for the individual image segments. Based on the determined homogeneity values, the evaluation of the manufactured component layer is then carried out by the computing device.

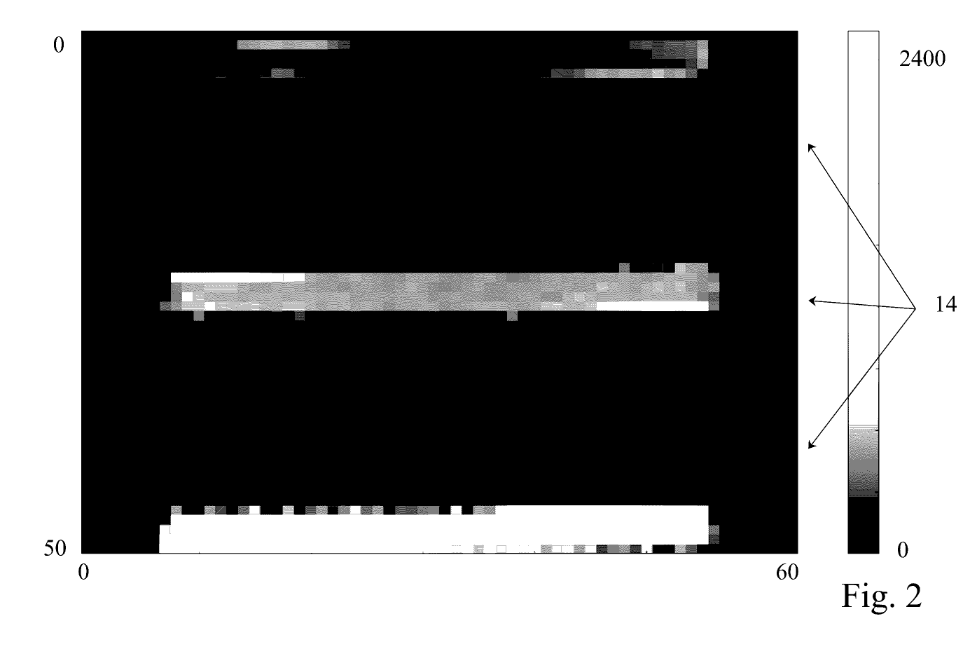

For this purpose, FIG. 2 shows the calculated homogeneity values for the individual image segments of the image shown in FIG. 1. The homogeneity values were calculated in this case by a gray value co-occurrence algorithm. Each pixel thus characterizes the homogeneity of a 40×40 pixel image segment of the original gray-scale image, so that the image shown in FIG. 2 has a resolution of 60×50 pixels. According to the homogeneity scale also shown in FIG. 2, the individual homogeneity values are coded by gray scales that can assume values between 0 and 2400, wherein 0 corresponds to complete homogeneity and 2400 corresponds to strong inhomogeneity. Alternatively, the homogeneity values, however, can also be shown color-coded, of course, or can be represented in another way. It should be emphasized, however, that the individual image segments basically need not have a square resolution. In addition, the selection of the resolution of the image segments is aligned according to the resolution of the image and the geometry of the component layer. Correspondingly, each image segment can have, for example, a size of 10×10 pixels, 20×20 pixels, 30×30 pixels, 50×40 pixels, 50×20 pixels, etc. Likewise, it can be provided that each image segment images a size of approximately 1 mm² of the component layer.

A homogeneity value is determined for each image segment by the computing device and is employed for the evaluation of the component layer. The homogeneity value of each image segment is determined based on the co-occurrence matrix of the image segment, as has already been mentioned. Alternatively, the homogeneity value can be determined, for example, based on a histogram and the evaluation of the scatter of gray values (width of the histogram). Three regions 14 with higher inhomogeneity values can be recognized in FIG. 2; these regions correspond to the regions 12 shown in FIG. 1. In addition, it can be seen from FIG. 2 that the linear regions 12 that appear relatively similar in the gray-scale image in FIG. 1 actually greatly differ with respect to their homogeneity. By comparison with expected homogeneity values and/or homogeneity values adjacent to one another, the quality of the component layer can be evaluated. For example, the quality can be classified as “OK”, if no homogeneity value violates a predetermined variation criterion. Conversely, the quality can be classified as “not OK” if one or more homogeneity values violates the predetermined variation criterion.

In addition, it can be provided that the above-described method will be carried out for a plurality of or for all of the component layers. In this case, in addition to a two-dimensional evaluation, a three-dimensional evaluation is also possible by determining and evaluating the homogeneity values over several component layers. For example, up to 25 gray-scale images or more can be captured in the described manner and can be evaluated as a stack of images, whereby structural disturbances running obliquely through the observed component region can also be particularly reliably recognized. Likewise, it can be provided that an image stack composed of a plurality of gray-scale images is averaged and the resulting mean value pattern is subjected to the above-described homogeneity evaluation.

The parameter values indicated in the documents for the definition of process and measurement conditions for characterizing specific properties of the subject of the invention, also are to be viewed in the scope of deviations—for example, deviations based on measurement errors, system errors, DIN tolerances and the like, as encompassed by the scope of the invention.

What is claimed is:

1. A method for evaluating at least one component layer manufactured by an additive powder layer method, comprising the steps of:
capturing an image of the at least one component layer by a sensor device;
dividing the image into a multiple number of image segments by a computing device;
determining a homogeneity value for each image segment by the computing device; and
evaluating the component layer based on the determined homogeneity values by the computing device.

2. The method according to claim 1, wherein the image is captured as a gray-scale image by the sensor device, and/or is pre-processed after capture by the computing device and converted into a gray-scale image.

3. The method according to claim 1, wherein the image is divided into image segments of the same size and/or square image segments.

4. The method according to claim 1, wherein the image is divided into image segments only in image regions that contain at least one partial image of the component layer, and/or wherein the image is divided into image segments such that each image segment contains at least one partial image of the component layer.

5. The method according to claim 1, wherein edge regions of the component layer are considered when determining the homogeneity values.

6. The method according to claim 1, wherein at least one homogeneity value based on a frequency distribution of an image segment, based on a histogram, and/or based on a co-occurence matrix of an image segment, and/or based on at least one parameter from the group consisting of: color maximum value, color minimum value, and mean value is determined.

7. The method according to claim 1, wherein at least two manufactured component layers are evaluated.

8. The method according to claim 1, wherein, as a function of the evaluation, at least one process parameter of the additive powder layer method is varied for the following component layer.

9. The method according to claim 1, wherein an inadmissible powder accumulation and/or an inadmissible ejection from the melting bath is/are revealed when at least two homogeneity values are dissimilar to one another, violating a predetermined threshold value.

10. The method according to claim 1, wherein the at least one component layer is classified as admissible if the homogeneity values satisfy a predetermined variation criterion, or in that the at least one component layer is classified as inadmissible if the homogeneity values do not satisfy a predetermined variation criterion.

11. The method according to claim 1, further comprising the steps of:
providing a device including:
a sensor device configured and arranged to capture an image of at least one component layer manufactured by an additive powder layer method; and
a computing device configured and arranged to: a) divide the image into a multiple number of image segments; b) determine a homogeneity value for each image segment; and c) evaluate the component layer based on the determined homogeneity values.

12. The method according to claim 11, wherein the sensor device comprises at least one high-resolution detector and/or at least one IR-sensitive detector, in particular a CMOS and/or sCMOS and/or CCD camera for capturing IR radiation.

13. The method according to claim 11, wherein the device further includes an additive laser sintering and/or laser melting device, by which the at least one component layer is manufactured.
